(19) United States
(12) Patent Application Publication
(10) Pub. No.: US 2009/0059336 A1
(43) Pub. Date: Mar. 5, 2009

(54) System and Method for Display Illumination

(76) Inventors: James Christopher Dunphy, San Jose, CA (US); Hongqin Shi, San Jose, CA (US); Regis Grasser, Mountain View, CA (US); Jeffrey Scott Farris, Flower Mound, TX (US)

Correspondence Address: TEXAS INSTRUMENTS INCORPORATED, P O BOX 655474, M/S 3999, DALLAS, TX, 75265, US

(21) Appl. No.: 11/848,022

(22) Filed: Aug. 30, 2007

(51) Int. Cl. G02B 26/08

(52) U.S. Cl. 359/199

(57) ABSTRACT

System and method for increasing display brightness in laser illuminated display systems. An illumination source includes a light source to produce light, a disk having a set of lens elements arranged in a circular ring around a center of the disk, a motor coupled to the disk, and an external lens positioned in a light path of the coherent light source. As the disk rotates, the lens elements are moved sequentially through the light, angularly deflecting the light, which may be corrected by the external lens into a spatial deflection. The spatially deflected light may be used to simultaneously illuminate a surface with more than one color of light, thereby increasing the brightness of the light source.

### TECHNICAL FIELD

The present invention relates generally to a system and method for displaying images, and more particularly to a system and method for increasing display brightness in laser illuminated display systems.

### BACKGROUND

In a microdisplay-based projection display system, light from a light source may be modulated by the microdisplay as the light reflects off the surface of the microdisplay or passes through the microdisplay. Examples of commonly used microdisplays may include digital micromirror devices (DMD), deformable micromirror devices, transmissive or reflective liquid crystal, liquid crystal on silicon, ferroelectric liquid crystal on silicon, and so forth. In a digital micromirror device (DMD)-based projection system, where large numbers of positional micromirrors may change state (position) depending on an image being displayed, light from the light source may be reflected onto or away from a display plane.

For image quality reasons, it may be desirous to maximize the brightness of the images being displayed. In general, the brighter the images, the better the perceived image quality. Therefore, there have been many techniques utilized to help improve image brightness. Some of the techniques may include increasing the brightness of the light source, using multiple light sources, and so forth.

In a laser illuminated, microdisplay-based projection display system, it may be possible to maximize image brightness by increasing the duty cycle of the laser(s) used to illuminate the microdisplay. Scanning the light produced by the laser(s) so that more than one color of light may simultaneously illuminate the microdisplay may be performed to increase the duty cycle of the laser(s). That is, if only one color of light may illuminate the entire microdisplay at a time, then all of the other lasers must be turned off. However, if scanning permits the light from a red colored laser and the light from a green colored laser to illuminate different portions of the microdisplay, then the on-time of the two lasers may be increased, thereby increasing the duty cycle of the lasers.

### SUMMARY OF THE INVENTION

These and other problems are generally solved or circumvented, and technical advantages are generally achieved, by embodiments of a system and a method for increasing display brightness in laser illuminated display systems.

In accordance with an embodiment, an illumination source is provided. The illumination source includes a light source to produce light, a disk having a first set of lens elements arranged in a first circular ring around a center of the disk, each lens element periodically optically coupled to the light source, a motor coupled to the disk, and an external optical element positioned in a light path of the light source after the disk. The disk moves the lens elements in the first set of lens elements sequentially through the light, the motor rotates the disk, and the external optical element converts an angular refraction of the light into a spatial deflection.

In accordance with another embodiment, a display system is provided. The display system includes an illumination source, a microdisplay optically coupled to the illumination source and positioned in a light path of the illumination source after the illumination source, and a controller electronically coupled to the microdisplay and to the illumination source. The illumination source includes a light source to produce light, a rotatable disk having a set of lens elements arranged in a circumference around a center of the disk with each lens element equidistant from a center of the disk, the circumference in a light path of the light source, an optical element positioned in a light path of the light source after the light source, and an external lens positioned in a light path of the light source after the disk. The disk moves the lens elements in the set of lens elements through the light, the optical element expands the light along an axis perpendicular to the light path, and the external lens converts an angular refraction of the coherent light by the lens elements into a spatial deflection. The microdisplay produces images by modulating light from the illumination source based on image data, and the controller load image data into the microdisplay.

In accordance with another embodiment, a method of manufacturing a display system is provided. The method includes installing a light source configured to generate coherent light, installing a microdisplay in a light path of the display system after the light source, installing a controller configured to control the light source and the microdisplay, and installing a display plane in the light path of the display system after the microdisplay. The light source installing includes installing a coherent light source, installing a rotatable disk having a set of lens elements arranged along a circumference around a center of the disk, a light path of the coherent light source intersecting the circumference, installing a motor to rotate the disk, and installing an external lens in the light path after the disk.

An advantage of an embodiment is that little additional hardware is required. Furthermore, the additional hardware may be implemented inexpensively. Therefore, increased display brightness may be achieved with a small monetary investment.

A further advantage of an embodiment is that little noise is generated. Therefore, there is no source of distracting noise that may detract from the user's viewing enjoyment.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a side-view of a light source illuminating a microdisplay;

FIG. 1b is a diagram of a sequence of colored light produced by a light source;

FIG. 2a is a diagram of an exemplary microdisplay-based projection display system;

FIG. 2b is a diagram of a portion of an illumination system of the microdisplay-based projection display system;

FIG. 2c is a diagram of an isometric view of a disk;

FIG. 2d is a diagram of the refractive operation of an external lens;

FIG. 2e is a diagram of the reflective operation of an external lens;

FIGS. 2f and 2g are diagrams of cross-sectional views of a disk;

FIG. 3a is a diagram of top view of a portion of a disk;

FIGS. 3b and 3c are diagrams of cross-sectional views of a disk with a cylindrical and parabolic lens elements;

FIG. 4a is a diagram of a scanning of beams of light in a projection display system;

FIG. 4b is a diagram of the deflection of beams of lights by a lens element;

FIG. 4c is a diagram of a scanning of a microdisplay's surface;

FIGS. 5a through 5c are diagrams of alternate embodiments of a disk;

FIGS. 6a through 6c are diagrams of different types of disks;

FIG. 7a is a diagram of a cross-section of a disk with a powered lens element;

FIG. 7b is a diagram of a cross-section of a disk with a concave lens element;

FIG. 7c is a diagram of a cross-section of a disk with lens elements on both sides of the disk;

FIGS. 8a and 8b are diagrams of a disk with multiple sets of lens elements and an illumination system with such a disk;

FIG. 9 is a diagram of a top view of a disk; and

FIG. 10 is a diagram of a sequence of events in the manufacture of a microdisplay-based projection display system.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a laser illuminated, microdisplay-based projection display system, wherein the microdisplay is a DMD. The invention may also be applied, however, to other laser illuminated, microdisplay-based projection display systems, such as projection display systems utilizing deformable micromirror devices, transmissive or reflective liquid crystal displays, liquid crystal on silicon displays, ferroelectric liquid crystal on silicon displays, and so forth.

FIG. 1a illustrates a portion of a microdisplay-based projection display system 100. The microdisplay-based projection display system 100 includes a light source 105 and a microdisplay 110. The light source 105 may be used to provide light that illuminates the microdisplay 110. The light source 105 produces light one color at a time. FIG. 1b illustrates a time-space diagram of a sequence of colored light with N unique colors. For example, the light source 105 may produce color number 1 (block 120), which may be followed by color number 2 (block 125), which may be followed by the remaining N-2 colors, until the light source 105 may produce color number N (block 130). After producing color number N (block 130), the light source 105 may repeat the color sequence and produce color number 1 (block 120).

Although shown in FIG. 1a as each laser having equal duty cycle, the lasers of the light source may have different duty cycles. For example, in a three laser light source, a first laser may have a 1/5 duty cycle and the second laser and the third may have a 2/5 duty cycle. The duty cycle of each laser may depend on factors such as color perceived brightness, desired color point, laser power, and so forth. In light sources where certain colors may be produced by combining light from several lasers, the duty cycle of each laser may also differ. For example, in a RGBCYMW light source, there may be three separate lasers R, G, and B, while the colors C, Y, and M may be produced by combining light from two of the three lasers, and the color W may be produced by combining light from all three lasers.

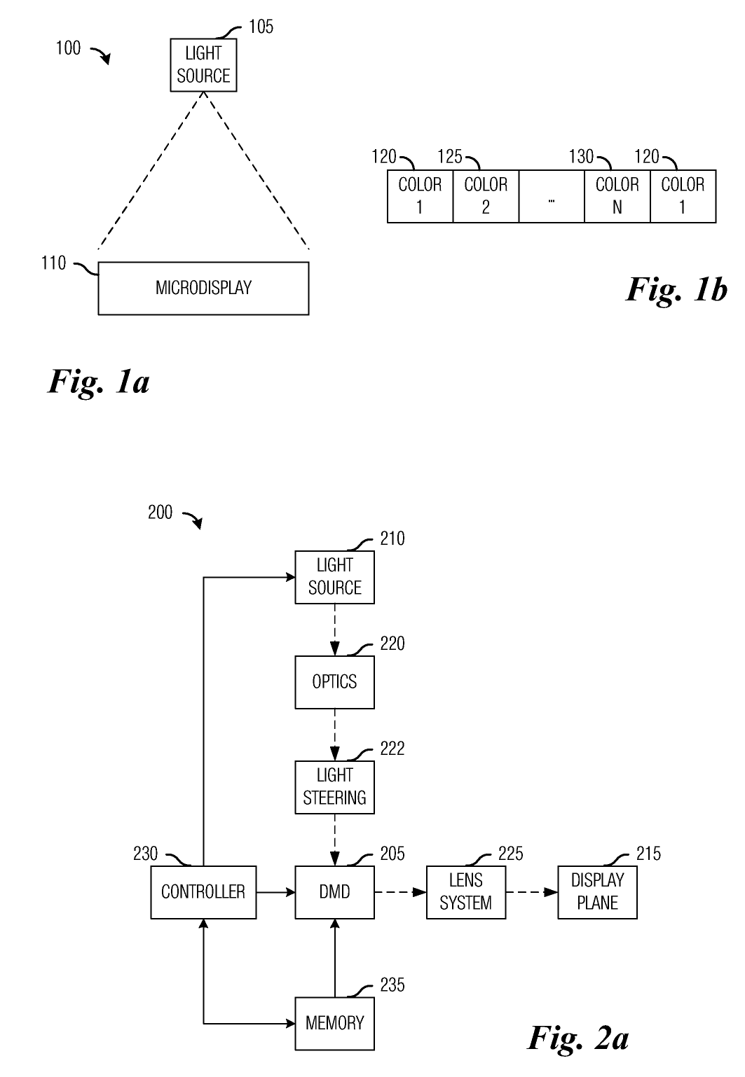

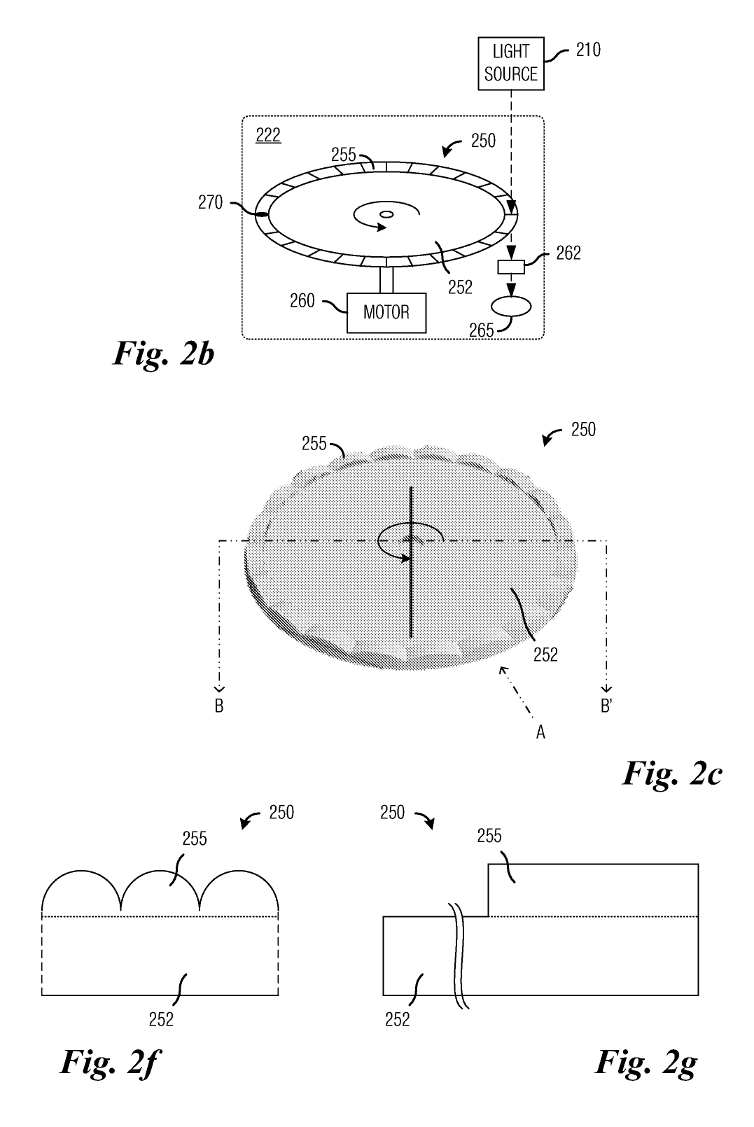

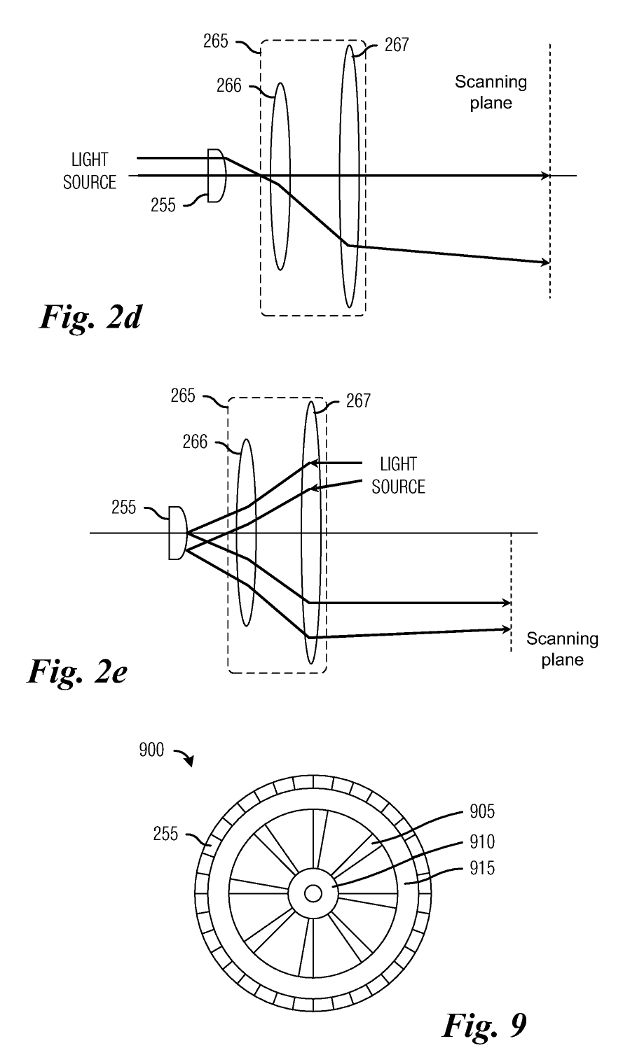

FIG. 2a illustrates an exemplary laser illuminated DMD-based projection display system 200. The DMD-based projection display system 200 includes a DMD 205 that modulates light produced by a light source 210. The light source 210 may make use of multiple lasers to produce the desired colors of light. Although the discussion focuses on solid-state lasers, other sources of coherent light, including filtered non-coherent light, free-electron lasers, and so forth, may be used in place of the solid-state lasers. Therefore, the discussion should not be construed as being limited to the present embodiments.

The DMD 205 is an example of a microdisplay or an array of light modulators. Other examples of microdisplays may include transmissive or reflective liquid crystal, liquid crystal on silicon, ferroelectric liquid-crystal-on-silicon, deformable micromirrors, and so forth. In a microdisplay, a number of light modulators may be arranged in a rectangular, square, diamond shaped, and so forth, array. Each light modulator in the microdisplay may operate in conjunction with the other light modulators in the microdisplay to modulate the light produced by the light source 210. The light modulated by the DMD 205 may be used to create images on a display plane 215. The DMD-based projection display system 200 also includes an optics system 220, which may be used to collimate the light produced by the light source 210 as well as to collect stray light. The DMD-based projection display system 200 may also include a lens system 225, which may be used to manipulate (for example, focus) the light reflecting off the DMD 205.

Also included in an optical path of the DMD-based projection display system 200 may be a light steering unit 222. The light steering unit 222 may be used to steer light from the light source 210 onto different portions of the DMD 205 and away from other portions of the DMD 205. This may allow for the simultaneous illumination of the DMD 205 by light of different colors. For example, a red colored light may illuminate a top third of the DMD 205, while a green colored light may illuminate a middle third of the DMD 205, and a blue colored light may illuminate a bottom third of the DMD 205. This may enable a higher duty cycle for the lasers used in the light source 210, thereby increasing the brightness of the images produced by the DMD-based projection display system 200. The light steering unit 222 will be discussed in greater detail below.

The DMD 205 may be coupled to a controller 230, which may be responsible for loading image data into the DMD 205, controlling the operation of the DMD 205, providing micromirror control commands to the DMD 205, controlling the light produced by the light source 210, and so forth. A memory 235, which may be coupled to the DMD 205 and the controller 230, may be used to store the image data, as well as configuration data, color correction data, and so forth.

FIG. 2b illustrates an isometric view of the light steering unit 222. The light steering unit 222 includes a disk 250 with disk body 252 and a plurality of lens elements 255. The plurality of lens elements 255 may be arranged along a periphery of the disk body 252. The lens elements 255 also may be evenly spaced about the periphery of the disk body 252. The disk 250 may be arranged so that light produced by the light source 210 may be incident on the disk 250 and the plurality of lens elements 255 with an angle of incidence less than or equal to an acceptance angle of the lens elements 255. Preferably, the light from the light source 210 should be orthogonal to the disk 250 and the lens elements 255. Furthermore, the disk 250 may be arranged so that the light from the light source 210 is incident mainly on the lens elements 255 and not the disk body 252 nor should a significant amount of the light miss the disk 250. FIG. 2c illustrates an isometric view of a rendering of the disk 250.

Although shown in FIGS. 2b and 2c as being arranged along the periphery of the disk body 252, the plurality of lens elements 255 may be arranged so that there may be a portion of the disk body 252 on either side of the plurality of lens elements 255. In other words, the plurality of lens elements 255 may be arranged in a ring with a radius that is smaller than a radius of the disk 250.

The individual colored beams of light from the lasers of the light source 210 should be focused to a small spot or a line running along the radial direction of the disk 250. The individual colored beams of light may be arranged so that they are focused on spots that are all substantially equidistant from a center of the disk 250. The individual colored beams of light also may be separated along the circumference of an individual lens element 255. The separation between the focusing spots of the individual colored beams of light may be dependent on a desired phase difference between the light produced by the disk 250. To mitigate far field limitations, the focusing spots of the individual colored beams of light generally should be as close together as possible while meeting desired phase differences. For example, to produce a 120 degree phase difference between the light produced by the disk 250 in a projection display system utilizing three individual colored beams of light, the focusing spots should be separated by about ⅓ of the width of an individual lens element 255. If all of the lens elements 255 are about the same size, then the separation between the focusing spots may be +/− the width of an individual lens element 255. For example, if each lens element is one (1) unit length in width, then the focusing spots may be located at [0, 1/3, and 2/3] so that all three focusing spots may fit within a single lens element 255. Alternatively, the focusing spots may be located at [0, 4/3, 8/3] so that a first focusing spot is on a first lens element, a second focusing spot is on a second lens element, and a third focusing spot is on a third lens element, i.e., no two individual beams of colored light are incident on a single lens element.

The disk 250, including the disk body 252 and the lens elements 255, may be molded from a plastic, such as polymethylmethacrylate (PMMA), polycarbonate, polystyrene, cyclic olefin copolymer, cyclic olefin polymer, and so forth, a glass, or so on. The disk body 252 and the lens elements 255 may be formed in a single molding step or they may be molded separately and then attached to each other using an adhesive, glue, heat, sound waves, or so forth. Generally, care should be provided to ensure that significant light loss at an interface between the disk body 252 and the lens elements 255 is not incurred. Alternatively, the disk 250 may be roughly molded or machined and then receive final machining and polishing to a final state.

The disk 250 may be rotated by a motor 260 with the motor 260 coupled to the disk body 252. As the motor 260 rotates the disk body 252, the lens elements 255 may also be rotated. As a beam of colored light passes through the lens elements 255, it may be refracted by differing degrees, thereby producing a scan line of colored light. Refraction due to the lens elements 255 may cause each of the multiple beams of colored light to deflect up and down along an axis, tracing out (generating) a saw tooth pattern, for example.

In order to scan an entirety of a two-dimensional surface, such as the DMD 205, it may be necessary to scan a line of light over the surface of the DMD 205, producing a three-dimensional surface of light, rather than scanning a beam of light which results in a two-dimensional line of light. Therefore, it may be necessary to include a refractive optical element to convert the beam of colored light into a line of colored light. An optical element 262 positioned in an optical path of the light steering unit 222 after the disk 250 may operate as a refractive optical element and may be used to convert the scanned line of light into a scanned three-dimensional surface of light. The optical element 262 may be a lenticular array or a diffractive optical element, for example. Although shown positioned after the disk 250 in the light path of the light steering unit 222, the optical element 262 may be positioned prior to the disk 250. Furthermore, the optical element 262 may be placed after other optical elements in the light path of the light steering unit 222 after the disk 250.

It may also be desirable to linearize the saw tooth pattern created by the lens elements 255. An external lens (or lenses) 265 may then be used to 1) convert the angular refraction of the multiple beams of colored light into a spatial deflection, 2) correct for a defocusing of the individual beams of colored light along one axis of the lens elements 255 of the disk 250, and 3) correct for a non-linearity of the scanning created by the disk 250. The external lens 265 may typically be implemented with one or more aspherical lenses. For example, the external lens 265 may be implemented with an F-Theta lens with a reverse photolens architecture. FIGS. 2d and 2e illustrate exemplary ray traces showing the function of an F-Theta lens used as the external lens 265 with lens elements 255 that are refractive in nature (FIG. 2d) and reflective in nature (FIG. 2e).

As discussed above, an F-Theta lens may have the architecture of a reverse photolens comprising two lens, a divergent lens 266 followed by a convergent lens 267. The divergent lens 266 and the convergent lens 267 may have circular revolution surfaces and may be aspheric if the scan angle is large. The divergent lens 266 and the convergent lens 267 may also be replaced with similarly shaped mirrored surfaces. The negative distortion of the F-Theta lens may be used to correct for scan non-linearity. It may also be possible to add an additional lens to the external lens 265 with an orthogonal power axis (for example, power along an X axis) to correct for uni-dimension power induced by the lens elements 255.

With reference back to FIG. 2b, the rate of rotation of the disk 250 may be dependent on the size of the lens elements 255, the size of the microdisplay (DMD 205, for example), the desired scan rate of the colored beams of light, the frame rate of the DMD-based projection display system 200, and so forth. For example, in a three-color DMD-based projection display system with a frame rate of 60 Hz and a disk 250 with twenty (20) lens elements 255, then each lens element 255 will encompass 360 degrees/20 lens elements=18 degrees per lens element. To achieve a scan rate for the colored beams of light of eighty (80) times the frame rate (e.g., each colored beam of light will scan the DMD 205 eighty times per frame) would require that frame_rate×scan_rate=60×80=4800 lens elements 255 pass underneath the light source 210 per second. With 20 lens elements 255 on the disk 250, the rotation of the disk 250 would need to be 4800 lens elements per second/20 lens elements per revolution=240 revolutions per second or 14400 revolutions per minute.

The disk 250 may also have an index mark 270. The index mark 270 may be positioned at some known location on the surface of the disk 250, such as in the arrangement of lens elements 255. The index mark 270 may then be read by a sensor to signal an orientation of the disk 250 and may be used for synchronization with the controller 230 and the DMD 205. The index mark 270 may be optical in nature or it may be magnetic, for example. Alternatively a sensor may be included in the light path of the DMD-based projection display system to detect light beam position to provide synchronization information to the controller 230 and the DMD 205.

FIGS. 2f and 2g illustrate an edge on view of a portion of the disk 250 and a cross-sectional view of one-half of the disk 250. FIG. 2f illustrates a side view (an edge-on view) of a portion of the disk 250 along line “A” shown in FIG. 2c and FIG. 2g illustrates a view of one-half of the disk with a cut in the disk 250 made along line B-B′. The curvature of the lens elements 255 may be exaggerated for illustrative purposes. The actual curvature of the lens elements 255 may be different from the illustration, depending on the optical power of the lens elements 255.

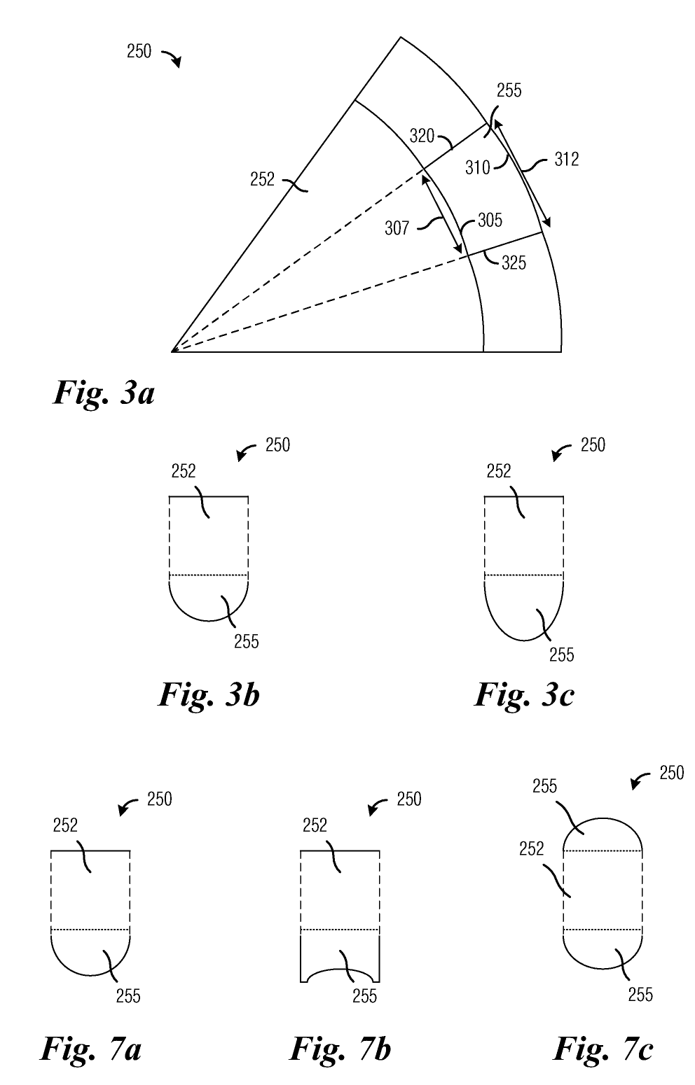

FIG. 3a illustrates a top view of a portion of the disk 250. Preferably, each lens element 255 has a cross-section of a cylindrical lens. However, since the lens elements 255 are arranged around the periphery of the disk body 252, the shape of the lens elements 255 may not match exactly with that of a cylindrical lens. For example, a first edge 305 of the lens element 255 may be shorter (shown as span 307) than a second edge 310 of the lens element 255 (shown as span 312). Additionally, a third edge 320 of the lens element 255 and the fourth edge 325 of the lens element 255 may not be parallel and may converge at the center of the disk 250. Therefore, each lens element 255 may be best described as an acylindrical lens, which is a cylindrical lens with high-order corrections. FIG. 3b illustrates a cross-sectional view of the disk 250 along an axis orthogonal to a radial axis of the lens element 255, wherein the lens element 255 has an acylindrical cross-section.

Alternatively, rather than having an acylindrical cross-section, the lens elements 255 may have a parabolic cross-section along an axis orthogonal to a radial axis of the disk 250. A parabolic cross-section may yield a linear scan angle through an illumination system of a projection display system. Furthermore, the parabolic cross-section may not significantly distort the focus of the beam of light produced by the light source. FIG. 3c illustrates a cross-sectional view of the disk 250 along an axis orthogonal to a radial axis of the lens element 255, wherein the lens element 255 has a parabolic cross-section.

The surface of the lens elements 255 with a parabolic cross-section may be described as Z=A+B*Y², where Y is a Cartesian coordinate that is tangential to the circumference of the disk 250, and A and B are coefficients. The parabolic cross-section of the lens elements 255 may vary along a radial coordinate (X) and may be described as Z=A+B*Y²+C*X*Y², where C is a coefficient. If coefficient C is set to be about equal to −B/Rcenter, where Rcenter is the radius of a beam center, e.g., a radius from the center of the disk 250 to the center of the lens elements 255, then the scan angle range may be independent of radius. Furthermore, if coefficient C is set to be about equal to 2*(−B/Rcenter), then a scan direction of the center beam may be kept constant, independent of angle of the disk 250. A preferred range of values for the magnitude of the coefficient C is from about zero (0) to about 3*B/Rcenter.

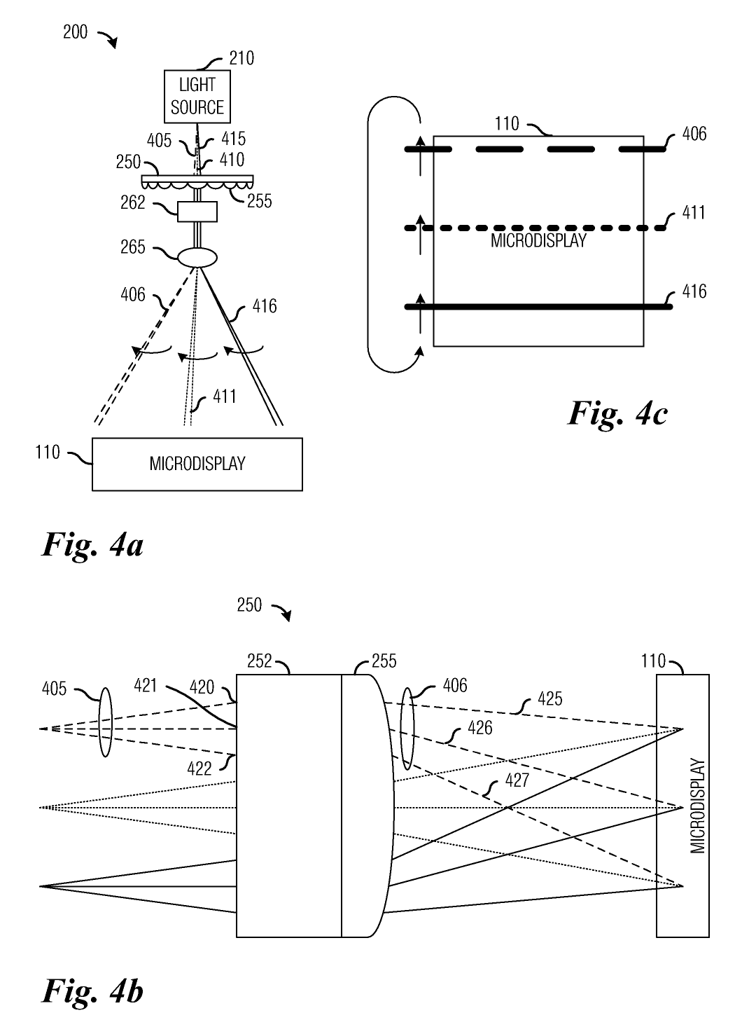

FIG. 4a illustrates a view of a portion of an illumination system of a microdisplay-based projection display system, such as the DMD-based projection display system 200. The illumination system includes the light source 210 and the disk 250. The disk 250 may be rotated at a desired rate by a motor. The light source 210 may simultaneously produce multiple beams of colored light that may be focused on the lens elements 255 of the disk 250. For example, in a four color system with the light source 210 may have two lasers producing different wavelengths of a single color or in a seven-color (RGBCYMW) projection display system, the light source 210 may simultaneously produce two or more of the seven available colors. For some colors, such as R, G, and B, a single light source producing a single wavelength of light may be needed, while for other colors, multiple light sources with each light source producing a single wavelength of light may be needed.

With the disk 250 rotating, the multiple beams of colored light will pass through the individual lens elements 255 as the lens elements 255 rotate under the multiple beams of colored light. Refraction due to the lens elements 255 may cause the multiple beams of colored light deflect up and down along an axis, generating a saw tooth pattern. The external lens (or lenses) 265 may then be used to convert the angular refraction of the multiple beams of colored light into a spatial deflection. The spatial deflection may then result in the multiple beams of colored light to scan over the surface of the microdisplay 110, for example, a DMD. For example, a first beam of colored light 405 may be incident to a lens element before a second beam of colored light 410 and a third beam of colored light 415 due to an arrangement of the multiple beams of colored light and a direction of rotation of the disk 250.

As the first beam of colored light 405 passes through the lens element 255, a first refracted light beam 406 may be scanned over the surface of the microdisplay 110. Similarly, the second beam of colored light 410 becomes a second refracted light beam 411 and the third beam of colored light 415 becomes a third refracted light beam 416 after passing through the lens element 255. Since the second beam of colored light 410 and the third beam of colored light 415 are incident on the lens element 255 after the first beam of colored light 405, their respective refracted beams scan over the surface of the microdisplay 110 after the first refracted light beam 406. A spacing between the first, second, and third refracted light beams 406, 411, and 416 may be dependent upon factors such as a spacing between the first, second, and third beam of colored light 405, 410, and 415, as well as the optical properties of the lens elements 255.

FIG. 4b provides a detailed view of the scanning properties of the lens element 255. As the lens element 255 moves through a beam of colored light, such as the first beam of colored light 405, a degree to which the lens element 255 refracts the light depends on the location of the first beam of colored light 405 on the lens element 255. FIG. 4b illustrates three exemplary locations of the first beam of colored light 405 on the lens element 255. For example, the first light beam of colored light 405 focused at location 420 may be refracted by the lens element 255 to form light beam 425. Similarly, the first light beam of colored light 405 focused at locations 421 and 422 may be refracted to form light beams 426 and 427, respectively.

As a beam of colored light passes through a lens element 255, the beam of colored light is refracted by varying degrees depending on the location of the beam of colored light on the lens element 255 so that the refracted beam of colored light is scanned over the surface of the microdisplay 110. After the lens element 255 is moved through the beam of colored light, another lens element 255 begins its rotation through the beam of colored light. Therefore, as each lens element 255 moves through the beam of colored light, a refracted beam of colored light is scanned over the surface of the microdisplay 110, with the rate of the scan being dependent on the rotational velocity of the disk 250.

FIG. 4c illustrates a diagram of a top-view of the microdisplay 110 with several refracted beams of colored light 406, 411, and 416. As shown in FIG. 4c, the refracted beams of colored light 406, 411, and 416 move up the surface of the microdisplay 110. After a refracted beam of colored light, such as the first refracted beam of colored light 406, moves off the surface of the microdisplay 110 or its respective beam of colored light (the first beam of colored light 405) exits a lens element 255, another lens element 255 is moved under the respective beam of colored light and the refracted beam of colored light 406 reappears on the surface of the microdisplay 110. As long as the lens elements 255 are in motion, the refracted beams of colored light 406, 411, and 416 are created on the surface of the microdisplay 110 and are moved over the surface of the microdisplay 110.

The number of refracted beams of colored light simultaneously illuminating the surface of the microdisplay 110 may be dependent on the rotation speed of the disk 250, the number of lens elements 255 on the disk 250, the size of the individual lens elements 255, the data movement restrictions of the microdisplay, and so forth. For example, if the rotation speed of the disk 250 is high and the number of lens elements 255 is high, then the scan rate of the refracted beams of colored light may also be high, implying a large number of refracted beams of light illuminating the surface of the microdisplay 110. However, there are limitations on how rapidly image data can be moved into the microdisplay 110, and the scan rate may need to be reduced to ensure that proper image data is loaded into the microdisplay 110 prior to the microdisplay 110 being illuminated by a respective refracted beam of colored light. However, if the microdisplay 110 may be illuminated by two or more refracted beams of light, a net improvement in the brightness of the images generated may be realized.

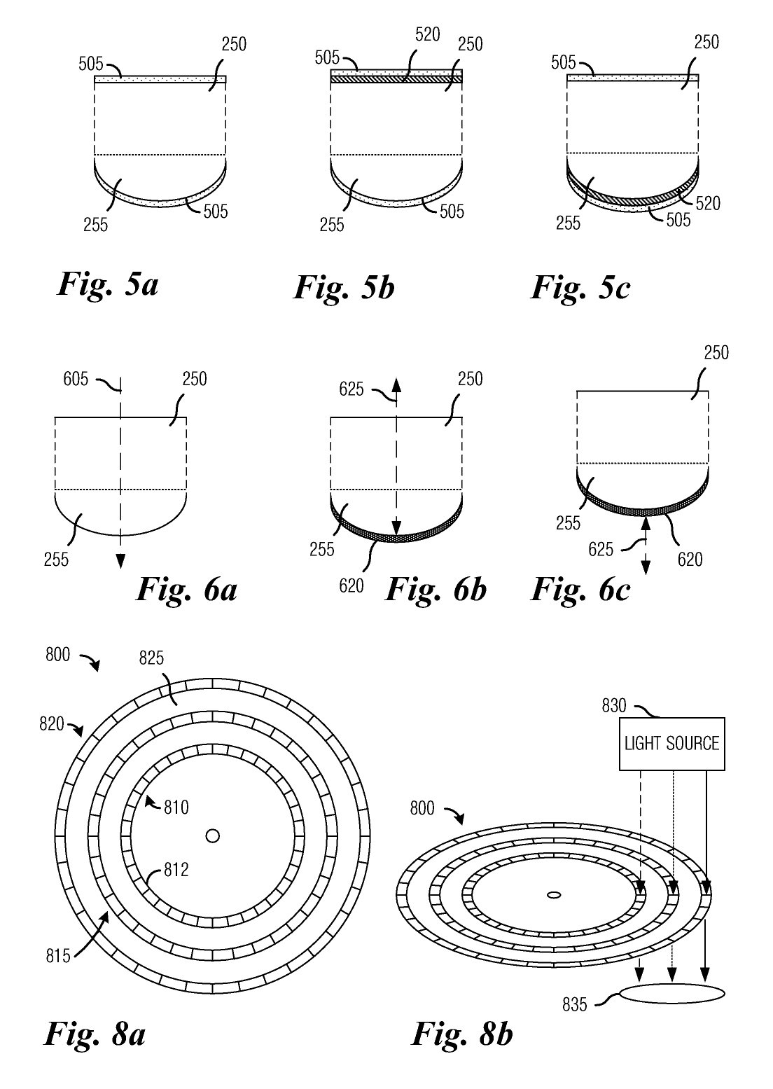

Some or all of the lens elements 255 of the disk 250 may be modified to adjust performance as needed. FIG. 5a illustrates a cross-sectional view of the disk 250 along an axis orthogonal to a radial axis of a lens element 255. An antireflective coating 505 may be applied to the external surface of the lens elements 255 and the disk 250 to help reduce light loss. To minimize light loss, both external surfaces should be coated with the antireflective coating 505. Although shown in FIG. 5a with the antireflective coating 505 on both the external surface of the lens element 255 and the disk 250, it may be possible to apply the antireflective coating 505 to only one (or neither) of the two surfaces.

It may be useful to purposefully increase the light loss of some or all of the lens elements 255 of the disk 250. Increased light loss may help to reduce a minimum amount of displayable light, potentially darkening a darkest displayable grayscale. This may result in an increase in the bit-depth of displayed images. FIG. 5b illustrates a cross-sectional view of the disk 250 along an axis orthogonal to a radial axis of a lens element 255. A neutral density filter layer 520 may be applied to the external surface of the lens elements 255 and/or the disk 250 to help increase light loss. Although shown to be applied underneath the antireflective coating 505 on the disk 250, the neutral density filter layer 520 may be applied above the antireflective coating 505. Additionally, the antireflective coating 505 may be omitted altogether. FIG. 5c illustrates a cross-sectional view of the disk 250 along an axis orthogonal to a radial axis of a lens element 255 with the neutral density filter layer 520 applied to an external surface of the lens element 255.

FIG. 6a illustrates a cross-sectional view of the disk 250 along an axis orthogonal to a radial axis of a lens element 255, wherein the disk 250 and the lens element 255 are refractive in nature. Being refractive, the disk 250 and the lens element 255 may pass a light beam 605 incident to the disk 250. As the light beam 605 passes through the lens element 255, the light beam 605 may be refracted (bent) prior to exiting the lens element 255. FIG. 6b illustrates a cross-sectional view of the disk 250 along an axis orthogonal to a radial axis of a lens element 255, wherein a reflective coating 620 may be applied to an external surface of the lens element 255. With the reflective coating 620 applied to the external surface of the lens element 255, a light beam 625 may be reflected back through the lens element 255 and the disk 250, and exiting on an incident surface. An advantage of the reflective coating 620 may be that since the light beam 625 passes through the lens element 255 twice, rather than once as with the purely refractive disk 250 and lens element 255, the lens element 255 may be made flatter. FIG. 6c illustrates a cross-sectional view of the disk along an axis orthogonal to a radial axis of a lens element 255, wherein the light beam 625 does not pass through the disk 250 or the lens element 255, but reflects directly from a powered side of the lens element 255, which is coated with a reflective coating 620. An advantage of the configuration shown in FIG. 6c may be that the lens element 255 may be made flatter than a comparable refractive design and the optical properties of the material used in the disk 250 and the lens elements 255 are not critical since light does not pass through the material.

The lens elements 255 may also have more power along a first axis than a second axis. FIG. 7a illustrates a cross-sectional view of the disk 250 along a radial axis of a lens element 255, wherein the lens element 255 is a powered lens. For example, if the lens element 255 has more power along the Y axis (the coordinate axis tangential to the circumference of the disk 250), then the overscan in the Y axis may be increased, while if the lens element 255 has more power along the X axis (the radial coordinate axis), then the overscan in the X axis may be increased. If overscan in one axis is increased, then the amount of light along that axis incident on the surface of the microdisplay 110 may be reduced. For example, if the overscan is in the X axis, then the scan line may be made longer and less light may fall on the surface of the microdisplay 110, while if the overscan is in the Y axis, then the scan line may be made thicker and less bright. Altering the amount of light incident on the surface of the microdisplay 110 may help to increase image brightness to improve image quality or decrease image brightness to increase contrast ratio.

In addition to having a convex cross-section as shown in earlier figures, the lens element 255 may have a concave cross-section. FIG. 7b illustrates a cross-sectional view of the disk 250 along a radial axis of a lens element 255, wherein the lens element 255 has a concave cross-section. The concave lens element 255 may have a profile similar to the profile of the lens elements 255 shown previously, such as an acylindrical or parabolic profile.

FIG. 7c illustrates a cross-sectional view of the disk 250 along a radial axis of a lens element 255. However, rather than having optical power on one side of the disk 250, the lens element 255 may have optical power on both sides of the disk 250. Having optical power on both sides of the disk 250 may enable the use of lens elements 255 with smaller profiles, thereby potentially enabling a thinner disk 250.

FIG. 8a illustrates a top-view of a disk 800. Rather than having a single ring of lens elements, such as lens elements 255 of the disk 250 that may be shared by all beams of colored light, each beam of colored light may have its own set of lens elements. FIG. 8a illustrates the disk 800 with three sets of lens elements. A first set of lens elements 810 may be used by a first colored light, a second set of lens elements 815 may be used by a second colored light, and a third set of lens elements 820 may be used by a third colored light. Each set of lens elements may contain a plurality of individual lens elements, such as lens element 812, with the individual lens elements 812 arranged in circular fashion. The various sets of lens elements may be separated by an annular ring of disk material, such as annular ring 825 separating the second set of lens elements 815 and the third set of lens elements 820.

The separation between sets of lens elements may be dependent on factors such as proximity of the beams of colored light, the size of the light source producing the beams of colored light, the size of the lens elements, the size of the light beams, and so forth. For example, if individual beams of colored light may not be closer than a minimum distance apart, then their respective sets of lens elements may need to be similarly separated. Again, to mitigate far field limitations, the sets of lens elements 810, 815, and 820 should be positioned as closely together as possible.

Although the discussion focuses on an embodiment wherein each beam of colored light has its own set of lens elements, it may be possible to use a single set of lens elements with more than one beam of colored light, but not all of the beams of colored light. For example, two distinct beams of colored light may share a first set of lens elements, one beam of colored light may use a second set of lens elements, and finally, two distinct beams of colored light may share a third set of lens elements.

FIG. 8b illustrates an isometric view of a portion of an illumination system of a projection display system. The illumination system of a projection display system may include the disk 800, a light source 830, and an external lens 835. The external lens 835 may be used to convert the angular refraction of the multiple beams of colored light into a spatial deflection. It may also be possible to use a different external lens 835 for each set of lens elements. There may be one or more external lenses 835, with a number potentially being dependent on factors such as the wavelength of the beams of colored light being deflected, the separation between beams of colored light using a single set of lens elements, and so forth.

FIG. 9 illustrates a top view of a disk 900. The disk 900 may feature a number of spokes, such as spoke 905. The spoke 905 may physically couple a center hub 910 to a ring 915. The ring 915 may have a plurality of lens elements 255 arranged about its circumference. The use of spokes 905 may enable a construction of a disk with less mass than a solid disk. Although shown in FIG. 9 with eight spokes 905 and a single ring of lens elements 255, the disk 900 may be implemented with a larger or smaller number of spokes 905 and with additional rings of lens elements 255.

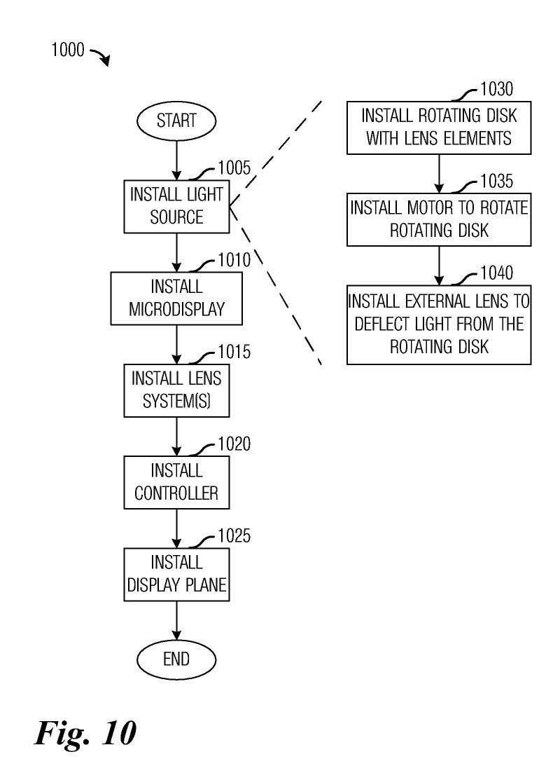

FIG. 10 illustrates a sequence of events 1000 in the manufacture of an exemplary microdisplay-based projection display system. The manufacture of the microdisplay-based projection display system may begin with installing a light source, which may produce multiple colors of light (block 1005). The installing of the light source may include the installing of a rotating disk containing a number of lens elements arranged along a periphery of the rotating disk (block 1030). Also installed may be a motor to rotate the rotating disk (block 1035). Furthermore, an external lens (lenses) may then be installed to deflect the light refracted by the lens elements on the rotating disk (block 1040).

The manufacture may continue with installing a microdisplay, such as a DMD, in the light path of the multiple colors of light produced by the light source (block 1010). After installing the microdisplay, a lens system may be installed in between the light source and the microdisplay (block 1015). A controller for the microdisplay-based projection display system may then be installed (block 1020). With the controller installed, the manufacture may continue with installing a display plane (block 1025). The order of the events in this sequence may be changed, the sequence may be performed in a different order, or some of the steps may be performed at the same time to meet particular manufacturing requirements of the various embodiments of the DMD, for example.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An illumination source comprising:
a light source to produce light;
a disk having a first set of lens elements arranged in a first circular ring around a center of the disk, each lens element periodically optically coupled to the light source, the disk to move the lens elements in the first set of lens elements sequentially through the light;
a motor coupled to the disk, the motor to rotate the disk; and
an external optical element positioned in a light path of the light source after the disk, the external optical element to convert an angular refraction of the light into a spatial deflection.

2. The illumination source of claim 1, wherein the light source produces multiple beams of different colored light, and wherein the light source is arranged so that the beams of different colored light are incident on the lens elements in the first set of lens elements at distinct locations.

3. The illumination source of claim 2, wherein the distinct locations are all substantially equidistant from the center of the disk.

4. The illumination source of claim 1, wherein the disk further comprises a set of second lens elements, the second lens elements arranged in a second circular ring around the center of the disk.

5. The illumination source of claim 4, wherein the lens elements in the first set of lens elements are a first distance from the center of the disk and the second lens elements in the set of second lens elements are a second distance from the center of the disk, and wherein the first distance is different from the second distance.

6. The illumination source of claim 5, wherein the light source produces multiple beams of different colored light, and wherein the light source is arranged so that at least one beam of colored light is incident on the first set of lens elements and at least another beam of colored light is incident on the set of second lens elements.

7. The illumination source of claim 1, wherein each of the lens elements in the first set of lens elements has a surface that is acylindrical, parabolic, and combinations thereof.

8. The illumination source of claim 7, wherein the lens elements have a cross-section along a radial coordinate may be expressed as:
Z=A+B*Y²+C*X*Y²,
where Y is a Cartesian coordinate tangential to a circumference of the disk, X is a radial coordinate, and A, B, and C are coefficients, and wherein C is set to be substantially equal to
−B/Rcenter,
where Rcenter is a radius of a center beam.

9. The illumination source of claim 7, wherein the lens elements have a cross-section along a radial coordinate may be expressed as:
Z=A+B*Y²+C*X*Y²,
where Y is a Cartesian coordinate tangential to a circumference of the disk, X is a radial coordinate, and A, B, and C are coefficients, and wherein C is set to be substantially equal to
−2*B/Rcenter,
where Rcenter is a radius of a center beam.

10. The illumination source of claim 1, wherein the disk and the first set of lens elements are created from a material selected from the group consisting of: polymethylmethacrylate, polycarbonate, glass, polystyrene, cyclic olefin copolymer, cyclic olefin polymer, and combinations thereof.

11. The illumination source of claim 1, wherein the lens elements in the first set of lens elements are coated with a coating selected from the group consisting of: an antireflective coating, a neutral density filter coating, and combinations thereof.

12. The illumination source of claim 11, wherein the neutral density filter coating is applied to only a subset of lens elements in the first set of lens elements.

13. The illumination source of claim 1, wherein the lens elements in the first set of lens elements have a reflective coating on a curved side of the lens elements.

14. The illumination source of claim 1, wherein the lens elements in the first set of lens elements have a greater refractive power along a first optical axis than along a second optical axis, with the first optical axis and the second optical axis being orthogonal to the light path.

15. A display system comprising:
an illumination source, the illumination source comprising,
a light source to produce light,
a rotatable disk having a set of lens elements arranged in a circumference around a center of the disk with each lens element equidistant from a center of the disk, the circumference in a light path of the light source, the disk to move the lens elements in the set of lens elements through the light,
an optical element positioned in a light path of the light source after the light source, the optical element to expand the light along an axis perpendicular to the light path, and
an external lens positioned in a light path of the light source after the disk, the external lens to convert an angular refraction of the coherent light by the lens elements into a spatial deflection;
a microdisplay optically coupled to the illumination source and positioned in a light path of the illumination source after the illumination source, the microdisplay configured to produce images by modulating light from the illumination source based on image data; and
a controller electronically coupled to the microdisplay and to the illumination source, the controller configured to load image data into the microdisplay.

16. The display system of claim 15, wherein the disk has multiple sets of lens elements, with lens elements of each set of lens elements arranged in a circular ring with a distinct radius from the center of the disk.

17. The display system of claim 15, wherein the optical element is positioned in the light path of the light source and either before the disk or after the disk.

18. The display system of claim 15, wherein the light source further comprises a synchronization unit to synchronize the disk and the controller, the synchronization unit comprising:
an index mark located on the disk; and
a sensor coupled to the disk and to the controller, the sensor to detect the index mark and provide information related to the index mark to the controller.

19. A method of manufacturing a display system, the method comprising:
installing a light source configured to generate coherent light, wherein the light source installing comprises,
installing a coherent light source,
installing a rotatable disk having a set of lens elements arranged along a circumference around a center of the disk, a light path of the coherent light source intersecting the circumference,
installing a motor to rotate the disk, and
installing an external lens in the light path after the disk;
installing a microdisplay in a light path of the display system after the light source;
installing a controller configured to control the light source and the microdisplay; and
installing a display plane in the light path of the display system after the microdisplay.

20. The method of claim 19, wherein the disk with the set of lens elements is manufactured by injection molding.
